(19) United States
(12) Patent Application Publication
(10) Pub. No.: US 2012/0314249 A1
(43) Pub. Date: Dec. 13, 2012

(54) METHODS AND SYSTEMS FOR REMINDING ABOUT PRINT HISTORY

(75) Inventors: John Poxon, Hertfordshire (GB); Pia Matikka, London (GB); Peter Kemsley, Hertfordshire (GB); Paul Chapman, Hertfordshire (GB); Kevin McNeil, Hertfordshire (GB)

(73) Assignee: Xerox Corporation, Norwalk, CT (US)

(21) Appl. No.: 13/158,581

(22) Filed: Jun. 13, 2011

(51) Int. Cl. G06K 15/00

(52) U.S. Cl. 358/1.15

(57) ABSTRACT

Methods and Systems for reminding about print history use an approach in which one or more conditions, such as print job name and/or file size, of a subsequently submitted print job are monitored to determine if the one or more conditions of the subsequent print job is substantially similar to a corresponding one or more conditions of a previous print job. A reminder message is displayed on a user interface if such a similarity so determined, and in response, a user can enter a selection of an option in the reminder message to handle the reminder message and/or control print processing of the subsequent and/or previous print job. The reminder messaging can be pre-configured and turned off, as required.

### TECHNICAL FIELD

Embodiments are generally related to data-processing systems and methods. Embodiments also relate in general to the field of computers and similar technologies and, in particular, to software utilized in this field. In addition, embodiments relate to methods and systems for reminding about print history. Furthermore, embodiments relate to print processing.

### BACKGROUND OF THE INVENTION

Printing devices such as printers, copiers and multi-function devices provide users with the ability to output documents on a wide variety of different media, such as paper, transparencies, card stock, etc. Each of these printing devices, for example, may include multiple trays for storing media. Users typically load different media in each tray and adjust the tray to accommodate the particular size and type. Some printing devices have counters and tracking devices which count and track the quantity of media in the tray as well as when the tray is empty. Many printing devices also have monitors for detecting the level of other consumables, such as toner or ink level in the toner or ink cartridge.

Many printing devices also have a built-in display and/or a touch screen for providing operator input for control of the device and for displaying operating information, diagnostic results, error messages and inventory information. Inventory information may include the status of the media trays, i.e., what type of media is loaded in which tray, and ink or toner level in the different ink or toner cartridges. Error messages may include which media tray is jammed.

Some network printers, such as the Xerox Phaser printers, are provided with special software which enables a network administrator to view printer input/output tray levels, consumable status and total pages printed (information which is typically available at the printer's display). This information is available through a built-in web server installed in the printer. Network administrators can access and manage this information directly from a standard web browser or any web-enabled application. If a user wishes to print a document at a desktop printer connected to the user's personal computer, all media and consumable information for the printer is available to the user at the printer.

In order to send a print job to any printer, whether it is a desktop printer connected directly to the user's personal computer or to a networked printer, a printer driver must be installed on the user's personal computer. A printer driver is software which controls the printer from the user's personal computer. The printer driver provides a user interface which may be accessed by the user through either through the operation system or an application program such as a word processing program. A typical printer driver user interface allows a user to select items such as paper size, paper source (auto, upper, lower, manual), copy count, orientation (landscape or portrait), color or gray scale.

Despite the aforementioned printing devices, print drivers and associated functionality, inefficient management of print jobs and associated wastes in terms of paper and time can still result. There is a need to provide improved methods and systems for print processing that can help improve management of print jobs.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It has been identified that users often send the same document repeatedly for printing unnecessarily. For example the Secure Print Queue at present allows repeat jobs to be sent of the same document. If this duplication is not intentional, i.e. the office worker accidently repeated sending the same documents. This is not efficient as these duplicate jobs are not in any way notified to the user, and when the user goes to the printer to release a job all jobs for that user are released at the same time. The result is duplicates of the same document thus resulting in unnecessary machine run time, and also a waste of resources (e.g.; paper—toner—ink). Similarly by referencing the recent print history a reminder could be sent with the print submission that you have recently printed that document.

The aforementioned aspects and other objectives and advantages can now be achieved as described herein.

According to one aspect, there is provided a method for reminding about print history. The method can comprise submitting a subsequent print job for printing on a printer; monitoring one or more conditions, such as print job name and/or file size of the subsequent print job to determine if the one or more conditions of the subsequent print job is substantially similar to a corresponding one or more conditions of a previous print job; in response to determining condition(s) of the subsequent print job is substantially similar to a corresponding condition(s) of the previous print job, displaying a reminder message on a user interface for reminding a user that the subsequent print job may be substantially similar to the previous print job.

The method can further comprise receiving a user interface entered selection relating to printing the subsequent print job and/or the previous print job in response to displaying the reminder message; and controlling handling of the reminder message and/or print processing of the subsequent print job and/or the previous print job according to the received user interface entered selection.

According to another aspect, there is provided a system for reminding about print history. The system comprising a processor; a data bus coupled to the processor; and a computer usable medium embodying computer program code, the computer usable medium being coupled to the data bus; and the computer program code comprising instructions executable by the processor and configured to: submit a subsequent print job for printing on a printer; monitor the one and more conditions of the subsequent print job to determine if the one and more conditions of the subsequent print job is substantially similar to a corresponding one and more conditions of a previous print job; in response to determining one and more conditions of the subsequent print job is substantially similar to a corresponding one and more conditions of the previous print job, display a reminder message on a user interface for reminding a user that the subsequent print job may be substantially similar to the previous print job.

According to yet another aspect, there is provided a computer-usable medium for reminding about print history, the computer-usable medium embodying computer program code, the computer program code comprising computer executable instructions configured for: submitting a subsequent print job for printing on a printer; monitoring one and more conditions of the subsequent print job to determine if the one and more conditions of the subsequent print job is substantially similar to a corresponding one and more conditions of a previous print job; in response to determining one and more conditions of the subsequent print job is substantially similar to a corresponding one and more conditions of the previous print job, displaying a reminder message on a user interface for reminding a user that the subsequent print job may be substantially similar to the previous print job.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system in which the present invention may be embodied;

FIG. 2 illustrates a schematic view of a software system including an operating system, application software, and a user interface for carrying out the present invention;

FIG. 3 illustrates a graphical representation of a network of a computer printing system in which aspects of the present invention may be implemented;

FIG. 4 illustrates a flow chart of a method for reminding about print history according to one embodiment;

FIG. 5. illustrates a flow chart detailing a more specific example of a method for reminding about print history according to one embodiment;

FIG. 6 illustrates a screen shot of an exemplary configurable print driver for print queue message according to one embodiment; and

FIG. 7 illustrates a screen shot of an exemplary reminder pop up according to one embodiment.

### DETAILED DESCRIPTION

The particular values and configurations discussed in these non-limiting examples can be varied and are cited merely to illustrate at least one embodiment and are not intended to limit the scope thereof.

For the purposes of discussion hereinafter, a “print job” refers to work that is to be completed for a customer or user so as to provide a print product. A “print product” is any product or logical unit of work produced by a print job. For example, a print product can be a booklet, a brochure or a single document. For example, a request to make 10 copies of a book is a print job. Similarly, a request to make 1, 100 or any number of copies of a single document is a print job.

Technical features described in this application can be used to construct various embodiments of methods and systems for reminding about print history, if necessary, and controlling print processing of print jobs. Systems and methods of the embodiments help prevent accidental repeat printing of the same document by the same person. For example, in one approach, the systems and methods identify documents with the same name and file size sent to the print queue and provide the user with a message containing options including accepting the action, cancelling the print or deleting the duplicate file. Benefits of the invention include the ability to save resources (e.g. paper—toner—ink) that would simply be discarded.

The following discussion is intended to provide a brief, general description of suitable computing environments in which the method and system may be implemented. Although not required, the method and system will be described in the general context of computer-executable instructions, such as program modules, being executed by a single computer. Generally, program modules include routines, programs, objects, components, data structures, etc., that perform particular tasks or implement particular abstract data types. Moreover, those skilled in the art will appreciate that the method may be practiced with other computer system configurations, including hand-held devices, multi-processor systems, microprocessor-based or programmable consumer electronics, networked PCs, minicomputers, mainframe computers, and the like.

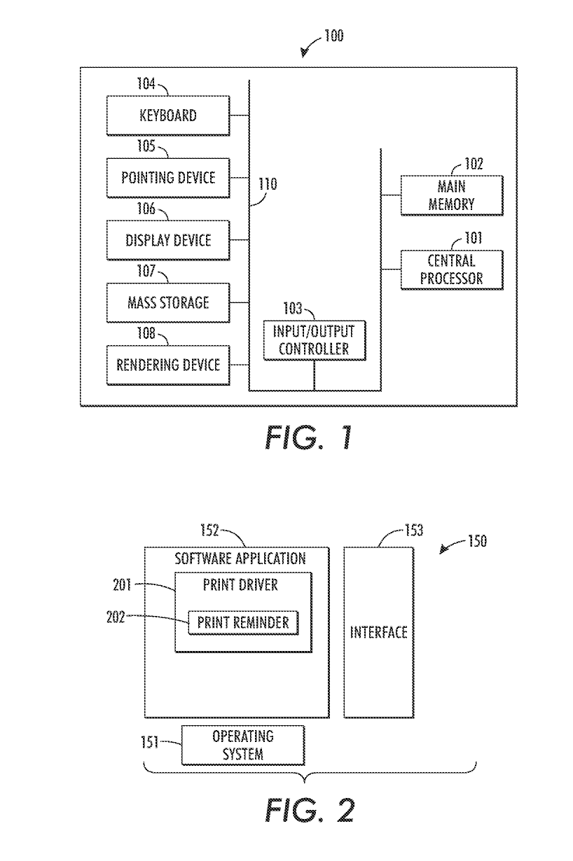

As depicted in FIG. 1, the present invention may be embodied in the context of a data-processing apparatus 100 comprising a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a rendering device 108, may be included in the data-processing apparatus 100 as desired. As illustrated, the various components of the data-processing apparatus 100 communicate through a system bus 110 or similar architecture. It can be appreciated that the data-processing apparatus 100 may be or include, in some embodiments a mobile computing device such as a Smartphone, a laptop computer, iPhone, etc. In other embodiments, data-processing apparatus 100 may function as a desktop computer, server, and the like, depending upon design considerations.

FIG. 2 illustrates a computer software system 150 for directing the operation of the data-processing apparatus 100 depicted in FIG. 1. Software system 150, which is stored in system memory 102 and on disk memory 107, can include a kernel or operating system 151 and a shell or interface 153. One or more application programs, such as application software 152, may be “loaded” (i.e., transferred from storage 107 into memory 102) for execution by the data-processing apparatus 100. The data-processing apparatus 100 receives user commands and data through user interface 153; these inputs may then be acted upon by the data-processing apparatus 100 in accordance with instructions from operating module 151 and/or application module 152.

Note that the term “module” as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term “module” may also simply refer to an application such as a computer program design to assist in the performance of a specific task such as word processing, accounting, inventory management, etc.

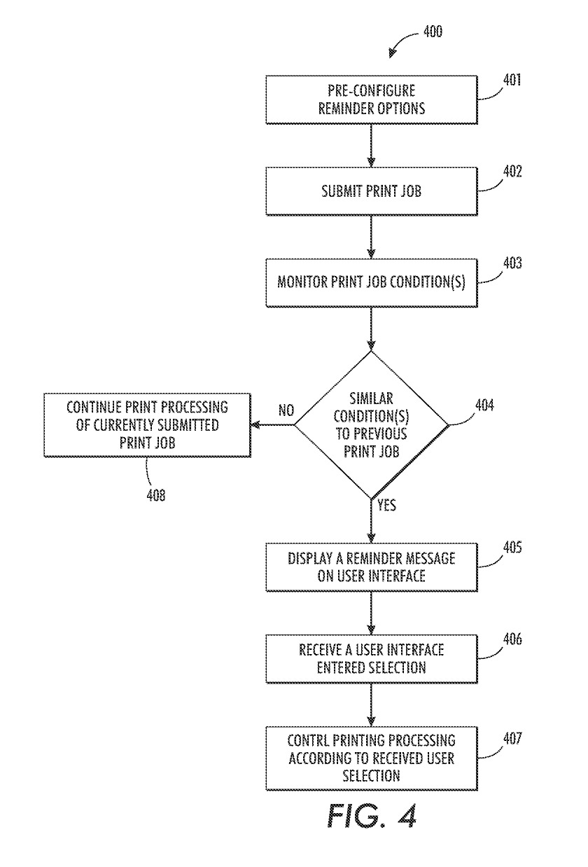

The interface 153, which is preferably a graphical user interface (GUI), also serves to display results, whereupon the user may supply additional inputs or, for example, terminate a given session. In one embodiment, operating system 151 and interface 153 can be implemented in the context of a “Windows” system. It can be appreciated, of course, that other types of systems are possible. For example, rather than a traditional “Windows” system, other operating systems such as, for example, Linux may be employed with respect to operating system 151 and interface 153 in another embodiment. Application module 152, on the other hand, can include instructions such as the various operations described herein (see for example, the methods depicted in FIGS. 4 & 5 of the accompanying drawings.) More specifically, in one example, the software application 152 can include modules 201-202. As will be explained in more detail below, print history reminder module 202 is adapted for reminding of print history and, if desired, for controlling print processing of print jobs and/or dealing with reminders in response to receiving user selected options. Print driver module 201 is adapted for converting data to be printed into format of specific printer 314. Print history reminder module 202 can be incorporated into the printer driver 201 as shown in FIG. 2. Alternatively, printer history reminder 202 can be a module separate from the printer driver 201 and adapted to communicate with the print driver module to enable the print history reminder module 202 to provide reminders of print history and control print processing, as necessary.

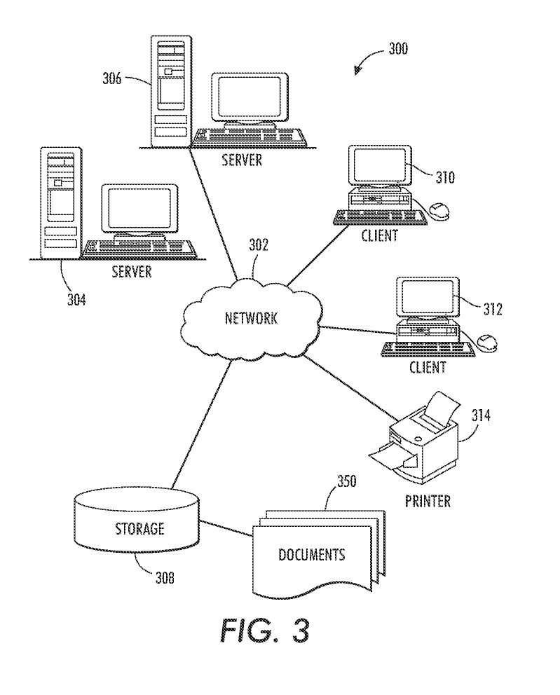

FIG. 3 illustrates a graphical representation of a network of computer printing system systems in which aspects of the present invention may be implemented. Network computer printing system 300 is a network of computers in which embodiments of the present invention may be implemented. Network computer printing system 300 contains network 302, which is the medium used to provide communication links between various devices and computers connected together within network computer printing system 100. Network 302 may include connections such as wire, wireless communication links, or fiber optic cables.

In the depicted example, servers 304 and 306 connect to network 302 along with storage unit 308. In addition, clients 310, 312, and printer 314 connect to network 302. These clients 310, 312, may be, for example, personal computers or network computers. Printer 314 may be for example a bi-directional Printer. Data-processing system 100 depicted in FIG. 1 can be, for example, a client such as client 310, and/or 312. Alternatively, data-processing system 100 can be implemented as a server such as servers 304 and/or 306, depending upon design considerations. In the depicted example, server 304 provides data such as boot files, operating system images, and applications to clients 310, 312. Clients 310, 312, are clients to server 304 in this example. Network computer printing system 300 may include additional servers, clients, printers and other devices not shown. Specifically, clients may connect to any member of a network of servers which provide equivalent content. It should be appreciated that the computational tasks described herein may be carried out on multiple servers that communicate their data and results over a network 302. It should also be appreciated that the clients 310, 312 may provide an interface to the user for collecting input and presenting results and can additionally communicate tasks to the servers 304 and/or 306 over the network 302.

Information on a user's print queue and on printed jobs can be kept on printer 314. Additional or alternatively, such information can be stored in an electronic form in a data storage 308 and/or in one or more of the clients or servers, and can include graphic or other information print queue and print job data. The information can be pre-stored in a suitable format. The input image data may also be distributed over multiple storage locations and accessible via a network (e.g., web pages accessible via the Internet and World Wide Web).

In the depicted example, network computer printing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes, or host computers, consisting of thousands of commercial, government, educational, and other computer systems that route data and messages. Of course, network computer printing system 300 also may be implemented as a number of different types of networks such as, for example, an intranet, a local area network (LAN), or a wide area network (WAN). FIG. 3 is intended as an example and not as an architectural limitation for different embodiments of the present invention.

FIGS. 1-3 are provided as exemplary diagrams of computer printing system environments and systems in which embodiments of the present invention may be implemented. It should be appreciated that FIGS. 1-3 are only exemplary and are not intended to assert or imply any limitation with regard to the environments in which aspects or embodiments of the present invention may be implemented. Many modifications to the depicted environments may be made without departing from the spirit and scope of the present invention. Note that in FIGS. 1-7, identical or similar parts are generally indicated by identical reference numerals.

The following description is presented with respect to embodiments of the present invention, which can be embodied in the context of a data-processing system such as data-processing system 100 and computer software system 150 depicted respectively in FIGS. 1-2. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

A method 400 for reminding about print history according to one embodiment will now be described. FIG. 4 is an outline of the processes of method 400. Initially, the reminder options are preconfigured (401), as desired. If such pre-configuration has already been performed, process 401 is not required and method 400 initiates with process 402. A print job subsequent to a previous print job is submitted for printing (402). A “subsequent” print job shall be referred to hereinafter as “print job” and a print job that is either previously submitted and printed, or previously submitted and pending, shall be referred to hereinafter as “previous print job”. One or more conditions related to the print job are monitored (403). If the condition(s) related to the print job are determined not to be substantially similar to a previous print job, print processing of the print job continues (404,408). If the condition(s) related to the print job are determined to be substantially similar to a previous print job, a reminder message is displayed on a user interface (404,405) reminding the user of the print history. A user interface entered selection is then received (406) as a result of a user entering an appropriate selection into the user interface. Print processing of the print job is then controlled according to the received user selection (407).

Method 400 is not limited to the particular sequence of processes shown in FIG. 4. It is to be noted that at least one of the processes 405, 406, 407 may be implemented via the same interface on which the reminder message is displayed or may be implemented through some other user interface at the same or a different location. Furthermore, processes 406,407 may be implemented via existing software and hardware rather through the print history reminder module. For example, following display or the reminder message, the user may opt to control print processing outside of the print history reminder module application and associated user interface, by using existing controls or devices independent of the print history reminder module. In processes 403 and 404, the condition(s) that are monitored and used to determine if the print job is substantially similar to a previous print job may be conditions(s) such as: 1. Print file document name; 2. Print file size, and/or 3. Date application file was made.

Turning now to the processes of method 400 in more detail. Non-limiting examples of the process of pre-configuring reminder options 401 may be for example: pre-configuring where a reminder message is to be delivered, pre-configuring conditions to be met to trigger reminder, pre-configuring the degree of matching between a print job and corresponding previous print job, and pre-configuring the type of options to be offered in a reminder message to enable a user to deal with the print job and reminder message.

Regarding the process 401 of pre-configuring reminder options, in one non-limiting example, a degree of matching between the print job and the previous print job for determining if the print job is substantially similar to a previous print job may can be pre-configured via the user interface. For example, the User can choose any or all of the aforementioned condition criteria (1), (2) and (3) to tailor accuracy of match required. By way of example, should the user chose only (1) “File name” of print job to be the same as a previous print job as the condition to be met to trigger reminder, this results in possibly the same match of the print job and previous print job. Should the user chose both (1) “File name” to be the same and (2) “Print file size” to be the same, this results in likely the same match of the print job and previous print job. Should the user chose all three (1)“File name” to be the same, (2) “Print file size” to be the same, and (3) “Date application file was made” to be the same, this results in exactly the same match of the print job and previous print job

By way of another example of pre-configuring the reminder options (401), a user can choose via the user interface where to look for a match between the print job and a previous print job. For example, the user can select to look for a match “only in existing print queue”, and, if desired, include a user definable time interval to look at printed/completed print jobs. For example, the user can select “include a 5 min interval to look at printed/completed print jobs”.

In another non-limiting example of pre-configuring the reminder options (401), by using user selectable options in the print driver user interface (assuming print history reminder user interface is integrated in print driver), the user can configure the printer such that it will remind them that a duplicate print job has been submitted. The reminder will also offer the users the options of deleting or replacing the existing job, or turn off the reminder. Non-limiting examples of configurable options for the user can be:

Where reminder message is delivered:
Pop Up message at PC
Message at printer when releasing secure jobs

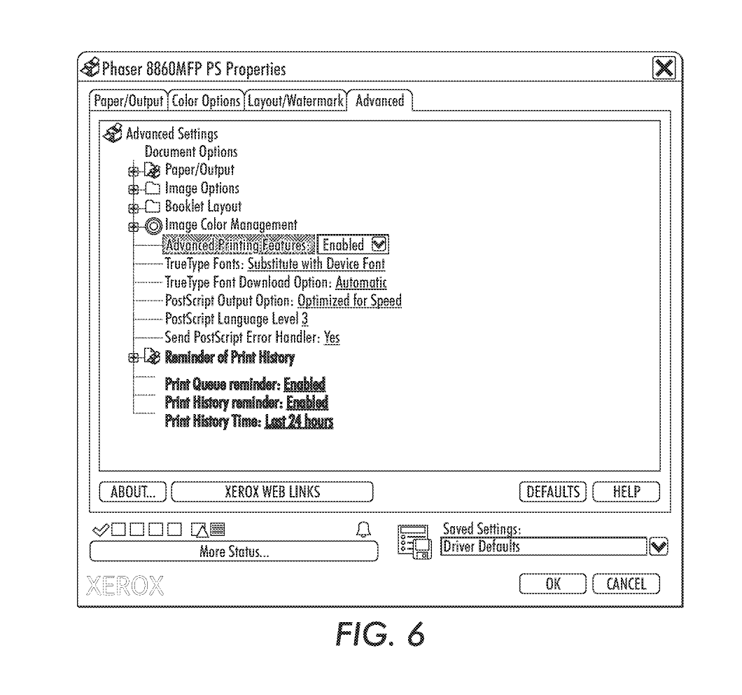

Conditions to be met to trigger reminder:
File name the same
File size the same
Job has been printed within (a user defined) predetermined time
Job is currently in the print queue
   An example of how some of the options might be configurable is shown in a screen shoot of an exemplary reminder message of FIG. 6.

In order to add usefulness to the reminder the pop up or other reminder message can be configured to offer the user options to deal with the print job and message.

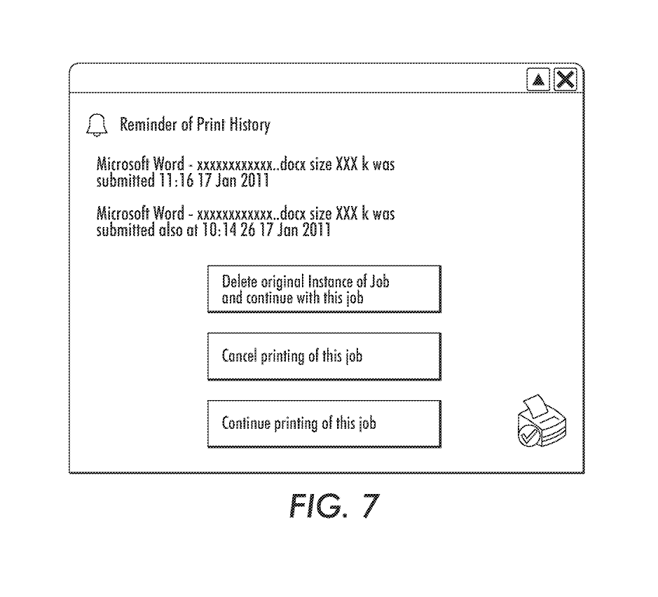

Exemplary options that can be configured to be available in reminder message may be:
Cancel print (because you have been reminded you have recently printed job out)
Cancel submission of job at PC (because you have been reminded that you have submitted it before)
Cancel submission of job at printer GUI (because you have been reminded that you have a similar job in queue)
Replace similar previous jobs in queue with current submission
Ignore reminder and continue with printing jobs
   FIG. 7 shows how an exemplary configured pop up reminder looks to the user.

There are different ways in which to implement process 403 of monitoring print jobs. The monitoring of the print jobs can be performed at different locations and/or on different devices. In one non-limiting example, a PC based SW monitors and tracks its own printed and queued jobs. The PCT based SW monitors print jobs sent on that PC keeping its own list independent of the printer and does not rely on a bi-directional link between the PC and printer. In another non-limiting example, information on users queue and on printed jobs can be monitored and kept on the printer. In yet another non-limiting example, information about print jobs can be monitored by the printer and the monitored information sent to a PC via a bi-directional communication link.

There are different ways in which to implement the process 405 of displaying the reminder message. The reminder message may be generated on different devices and/or at different locations. By way of non-limiting example, process 405 may be preformed by providing a Pop up message from the printer via bi-directional communications onto a users PC. By way of another non-limiting example, process 405 may be performed by providing a Pop up message from PC's print monitor SW on users PC. By way of yet another non-limiting example, process 405 may be performed by providing a Message on printer GUI for users, such as for example, when they go to release and stored/queued jobs.

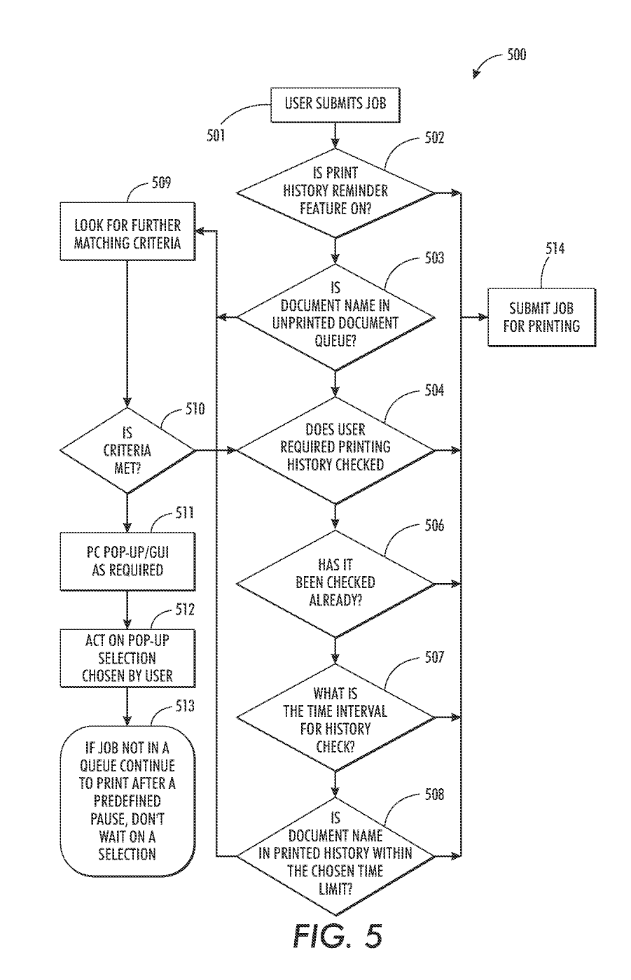

FIG. 5 illustrates a more detailed example of a method for reminding about print history according to one embodiment. Method 500 will be described with reference to FIG. 5 in conjunction with FIGS. 1-3, 6 and 7. Let us assume that the reminder options have already be pre-configured in the manner already described above and shown in FIG. 6. Method 500 initiates by a print job being submitted (501). For example, a user enters an input into the user interface 153 running on client PC 310 to cause the print job to be submitted for printing. Method 500 continues by determining whether the print history reminder feature is turned on (502). If the print history reminder feature is off, submission of the print job for printing continues (514). However, in this particular example the print history reminder feature is turned on (see FIG. 6) and method 500 continues to look to see if the print job document name is in unprinted document queue (503). If the print job document name is in the unprinted document queue, the method continues to look for further matching criteria for matching between print job and a previous print job (509). Examples of such matching criteria are discussed above. If criteria met (510), method continues by generating a PC pop up and/or print GUI pop as required (511). Example of the pop up is shown in FIG. 7. A user selects an option from the reminder pop up, such as for example “Delete original instance of job and continue with this job” and the method continues by acting on the Pop up selection chosen by the user (512).

In the event that the print job document name is not in the unprinted document queue (see 503) or matching criteria is not met (see 510), method 500 then continues by determining from pre-configured options whether user required printed history check (504). If no printed history check is required, method 500 proceeds by continuing to submit print job for printing (514). In this particular example, reminder options has been preconfigured to enable print history check (see FIG. 6) and so method 500 continues by determining if print history has already been checked (506). If print history has already been checked, method 500 proceeds by continuing to submit print job for printing (514). If print history has not already been checked, method 500 continues by determining the time interval for history check. (507). In this particular example, the time interval is pre-configured to “last 24 hrs” as shown in FIG. 6.

If the same document name as the print job is found in the print history within chosen time interval (508), in this example, last 24 hours, method 500 continues to the stage of looking for further matching criteria (509) which process has already been discussed above. If the same document name is not found in print history within chosen time interval (508), method proceeds by continuing to submit print job for printing (514).

As indicated in process 513, the reminder options can be configured such that if the print job condition, e.g. document name, is similar to a previous print job condition, and the print job is not in the queue (503), the method can either continue to submit the print job for printing (514) after a predetermined pause, or wait to act on a particular pop up selection to be made (513).

The methods and systems of the embodiments monitor the flow of documents/items/files of all types being submitted and being sent to the print queue with the same conditions, name and file size for example. This monitoring results in a message being sent to the user with a note/message of the item sent and an interface with options such as accept the action or to delete the duplicate file. The methods and systems of the embodiments help manage duplicated print jobs and associated wastes. Unintentional duplicate print jobs when printing remotely is reduced. The methods and system of the embodiments provide a useful user feature to any printer and enable easier (and less frustrating) management of print jobs, less waste (paper and time).

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art, which are also intended to be encompassed by the following, claims.

What is claimed is:

1. A method for reminding about print history, the method comprising:
submitting a subsequent print job for printing on a printer;
monitoring at least one condition of said subsequent print job to determine if said at least one condition of said subsequent print job is substantially similar to a corresponding at least one condition of a previous print job;
in response to determining at least one condition of said subsequent print job is substantially similar to a corresponding at least one condition of said previous print job, displaying a reminder message on a user interface for reminding a user that said subsequent print job may be substantially similar to said previous print job.

2. The method of claim 1, further comprising receiving a user interface entered selection in response to displaying the reminder message; and
controlling handling of the reminder message and/or print processing of the subsequent print job and/or said previous print job according to said received user interface entered selection.

3. The method of claim 1, further comprising
continuing with print processing of the subsequent print job after a predetermined time period.

4. The method of claim 2, wherein monitoring at least one condition of said subsequent print job comprises monitoring the file size and/or name of said subsequent print job to determine if the file size and/or name of said subsequent print job is substantially similar to the file size and/or name of a previous print job.

5. The method of claim 4, wherein monitoring at least one condition of said subsequent print job includes:
monitoring said file size and/or file name of said subsequent print job based on print job information held in said printer and/or held in a computer connectable to said printer; and
monitoring said file size and/or file name of the previous print job based on print job information held in said printer and/or held in a computer connectable said printer.

6. The method of claim 2, wherein displaying said reminder message further comprises displaying at least one option relating to printing the subsequent print job and/or the previous print job;
wherein receiving said user interface entered selection comprises receiving a user interface entered selection of said option, or one of said options.

7. The method of claim 6, wherein displaying at least one option relating to printing the subsequent print job comprises displaying an option to cancel printing the subsequent print job, delete a pending previous print job, and/or continue to print said subsequent print job.

8. The method of claim 2, wherein displaying a reminder message on a user interface for reminding a user that the subsequent print job is substantially similar to said previous print job comprises:
displaying said reminder message on a user interface of a computer operably connectable to the printer and/or displaying said reminder message on a user interface of said printer.

9. The method of claim 8, wherein receiving a user interface entered selection of said option, or one of said options, comprises receiving a selection of said option, or one of said options, entered through a user interface of said computer operably connectable to the printer or entered through a user interface of said printer.

10. The method of claim 2, further comprising determining the time and/or date of submission of said at least one previous print job; and
wherein displaying said reminder message further comprises displaying said
time and/or date of submission of said at least one previous print job.

11. The method of claim 2, further comprising pre-configuring said user selectable options of said reminder message; wherein pre-configuring said user selectable options comprises
displaying configurable reminder message options on said user interface; and
receiving user interface entered configuration of said user options for said reminder message.

12. A reminder system for reminding about print history, said system comprising:
a processor;
a data bus coupled to said processor; and
a computer usable medium embodying computer program code, said computer usable medium being coupled to said data bus; and said computer program code comprising instructions executable by said processor and configured to:
submitting a subsequent print job for printing on a printer;
monitor at least one condition of said subsequent print job to determine if said at least one condition of said subsequent print job is substantially similar to a corresponding at least one condition of a previous print job;
in response to determining at least one condition of said subsequent print job is substantially similar to a corresponding at least one condition of said previous print job, display a reminder message on a user interface for reminding a user that said subsequent print job may be substantially similar to said previous print job.

13. The system of claim 12, wherein said computer program code further comprises instructions executable by said processor and configured to:
receive a user interface entered selection in response to displaying said reminder message; and
control handling of the reminder message and/or print processing of the subsequent print job and/or said previous print job according to said received user interface entered selection.

14. The system of claim 12, wherein said computer program code further comprises instructions executable by said processor and configured to:
monitor and determine the file size and/or name of said subsequent print job is substantially similar to the file size and/or name of a previous print job.

15. The system of claim 14, wherein said computer program code further comprises instructions executable by said processor and configured to:
display at least one option relating to printing the subsequent print job and/or the previous print job; said at least one option comprising an option to cancel printing the subsequent print job, an option to delete a pending previous print job, and/or an option continue to print said subsequent print job; and
wherein receiving said user interface entered selection comprises receiving a user interface entered selection of said option, or one of said options.

16. The system of claim 12, wherein said previous print job comprises a previously printed print job or a previously submitted pending print job.

17. A computer-usable medium for reminding about print history, said computer-usable medium embodying computer program code, said computer program code comprising computer executable instructions configured for:
submit a subsequent print job for printing on a printer;
monitoring at least one condition of said subsequent print job to determine if said at least one condition of said subsequent print job is substantially similar to a corresponding at least one condition of a previous print job;
in response to determining at least one condition of said subsequent print job is substantially similar to a corresponding at least one condition of said previous print job, displaying a reminder message on a user interface for reminding a user that said subsequent print job may be substantially similar to said previous print job.

18. The computer-usable medium of claim 17, wherein said computer program code comprising computer executable instructions are further configured for
receiving a user interface entered selection in response to displaying said reminder message; and
controlling handling of the reminder message and/or print processing of the subsequent print job and/or said previous print job according to said received user interface entered selection.

19. The computer-usable medium of claim 18, wherein said computer program code comprising computer executable instructions are further configured for:
determining the file size and/or name of said subsequent print job is substantially similar to the file size and/or name of a previous print job.

20. The method of claim 19, wherein said computer program code comprising computer executable instructions are further configured for:
monitoring said file size and/or file name of said subsequent print job based on print job information held in said printer and/or held in a computer connectable to said printer; and
monitoring said file size and/or file name of the previous print job based on print job information held in said printer and/or held in a computer connectable said printer.
